(19) United States
(12) Patent Application Publication
(10) Pub. No.: US 2026/0211308 A1
(43) Pub. Date: Jul. 23, 2026

(54) ILLUMINATION SYSTEM AND PROJECTION DEVICE

(71) Applicant: Coretronic Corporation, Hsin-Chu (TW)

(72) Inventor: Yu-Hsiang Deng, Hsin-Chu (TW)

(73) Assignee: Coretronic Corporation, Hsin-Chu (TW)

(21) Appl. No.: 19/437,195

(22) Filed: Dec. 30, 2025

(30) Foreign Application Priority Data
Jan. 22, 2025 (CN) 202510099226.X

(51) Int. Cl. G03B 21/20; G02B 27/10

(52) U.S. Cl. CPC G03B 21/204; G02B 27/1006; G03B 21/2013; G03B 21/206; G03B 21/2066; G03B 21/208

(57) ABSTRACT

Provided is an illumination system, which includes a light source module, an optical path switching module, and a wavelength conversion layer. The light source module includes a first light source and a second light source, respectively configured to emit a first light beam and a second light beam. The optical path switching module is disposed in a transmission path of the first light beam, and includes a driving element and an optical element. The driving element is configured to drive the optical element to move to allow the optical path switching module to switch between a first state and a second state to change the transmission path of the first light beam. The wavelength conversion layer is disposed in the transmission path of the first light beam from the first light source or the optical path switching module. Also provided is a projection device.

### CROSS-REFERENCE TO RELATED APPLICATION

This application claims the priority benefit of China application serial no. 202510099226.X, filed on January 22, 2025. The entirety of the above-mentioned patent application is hereby incorporated by reference herein and made a part of this specification.

### BACKGROUND

### Technical Field

The disclosure relates to an optical system and an optical device, and in particular relates to an illumination system and a projection device.

### Related Art

With the development of projection technology, projection devices capable of projecting high brightness images have gradually gained attention in the market. Compared to traditional projection devices that require low brightness environments for clear image display, high brightness projection devices may allow users to view clear images even in an environment with higher brightness.

When a projection device utilizes a mode where a pure laser light source serves as the source of an illumination beam (hereinafter referred to as a pure laser mode), images with high brightness and high contrast may be generated. On the other hand, the projection device may also utilize a mode where a laser light source is used in conjunction with a phosphor wheel as the source of the illumination beam (hereinafter referred to as a mixed light source mode), which may increase the color gamut performance of the images generated by the projection device and enhance the image quality.

The pure laser mode and the mixed light source mode each have appropriate applications and advantages. How to provide a projection device that incorporates different modes and optimize its performance is still a problem to be solved by related manufacturers.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an illumination system and a projection device, which can switch between different light source modes to allow appropriate image qualities to be provided in different applications.

Other objectives and advantages of the disclosure may be further understood from the technical features disclosed in the disclosure.

To achieve one or part or all of the foregoing objectives or other objectives, an embodiment of the disclosure proposes an illumination system, which includes a light source module, an optical path switching module, and a wavelength conversion layer. The light source module includes a first light source and a second light source, respectively configured to emit a first light beam and a second light beam. The first light beam and the second light beam exit from the light source module in different directions. The optical path switching module is disposed in a transmission path of the first light beam from the first light source, and includes a driving element and an optical element. The driving element is configured to generate motion of the optical element, so that the optical path switching module switches between a first state and a second state to change the transmission path of the first light beam. The wavelength conversion layer is disposed in the transmission path of the first light beam from the first light source or the optical path switching module. The wavelength conversion layer is configured to convert the first light beam into a conversion beam. When the optical path switching module is in the first state, the wavelength conversion layer sequentially enters the transmission path of the first light beam. When the optical path switching module is in the second state, the wavelength conversion layer is not positioned in the transmission path of the first light beam.

To achieve one or part or all of the foregoing objectives or other objectives, an embodiment of the disclosure proposes a projection device, including the foregoing illumination system, a light valve, and a projection lens. The illumination system is configured to provide an illumination beam. The light valve is disposed in a transmission path of the illumination beam and configured to convert the illumination beam into an image beam. The illumination beam includes at least one of the first light beam, the second light beam, and the conversion beam. The projection lens is disposed in a transmission path of the image beam and configured to project the image beam out of the projection device.

Based on the above, the illumination system and the projection device according to the embodiment of the disclosure have at least one of the following advantages: in the illumination system and the projection device according to the embodiment of the disclosure, the optical path switching module is disposed in the transmission path of the first light beam, and the optical path switching module may switch between the first state and the second state by utilizing the driving element and the optical element of the optical path switching module to allow the illumination system and the projection device to switch between different light source modes. In this way, corresponding to different occasions, the illumination system and the projection device can both generate the image quality needed for the user to view or experience, enhancing the versatility of the illumination system and the projection device.

Other objectives, features and advantages of the disclosure will be further understood from the further technological features disclosed by the embodiments of the disclosure wherein there are shown and described preferred embodiments of the disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a schematic view of an optical path switching module of a projection device in a first state according to an embodiment of the disclosure.

FIG. 1B is a schematic view of the optical path switching module of the projection device shown in FIG. 1A in a second state.

FIG. 1C is a top view of the wavelength conversion element of the projection device shown in FIG. 1A.

FIG. 2A to FIG. 2B are respectively schematic side views of the optical path switching module shown in FIG. 1A and FIG. 1B in different states.

FIG. 3 is a timing diagram of the light source module shown in FIG. 1A.

FIG. 4A is a schematic side view of the light source module shown in FIG. 1A viewed towards a -X direction.

FIG. 4B is a schematic side view of the light guide assembly shown in FIG. 1A viewed towards a Y direction.

FIG. 5A to FIG. 5B are respectively schematic side views of an optical path switching module in different states according to another embodiment.

FIG. 6A is a schematic view of an optical path switching module of a projection device in a first state according to an embodiment of the disclosure.

FIG. 6B is a schematic view of the optical path switching module of the projection device shown in FIG. 6A in a second state.

FIG. 6C is a top view of the wavelength conversion element of the projection device shown in FIG. 6A.

FIG. 7A is a schematic view of an optical path switching module of a projection device in a first state according to an embodiment of the disclosure.

FIG. 7B is a schematic view of the optical path switching module of the projection device shown in FIG. 7A in a second state.

FIG. 7C is a top view of the wavelength conversion element shown in FIG. 7A.

FIG. 8A is a schematic view of an optical path switching module of a projection device in a first state according to an embodiment of the disclosure.

FIG. 8B is a schematic view of the optical path switching module of the projection device shown in FIG. 8A in a second state.

FIG. 8C is a top view of the wavelength conversion element when the optical path switching module of the projection device shown in FIG. 8A is in the first state.

FIG. 8D is a top view of the wavelength conversion element when the optical path switching module of the projection device shown in FIG. 8B is in the second state.

FIG. 9A is a schematic view of an optical path switching module of a projection device in a first state according to an embodiment of the disclosure.

FIG. 9B is a schematic view of the optical path switching module of the projection device shown in FIG. 9A in a second state.

FIG. 9C is a top view of the wavelength conversion element when the optical path switching module of the projection device shown in FIG. 9A is in the first state.

FIG. 9D is a top view of the wavelength conversion element when the optical path switching module of the projection device shown in FIG. 9B is in the second state.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

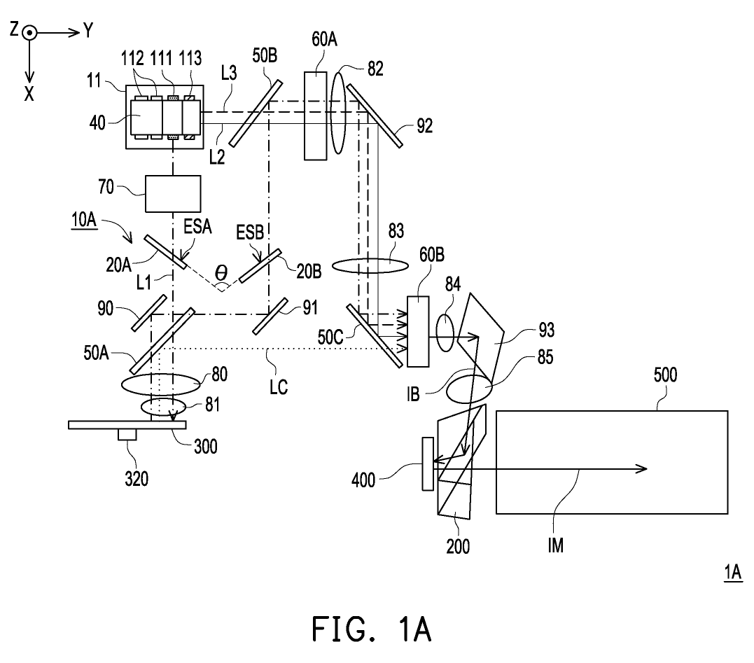

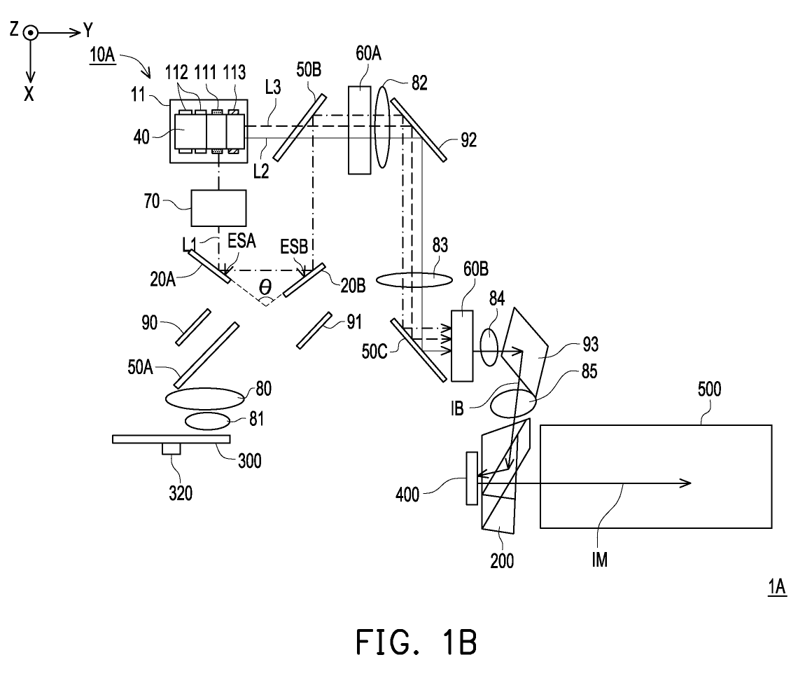

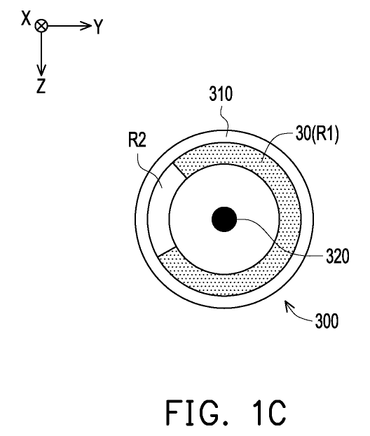

FIG. 1A is a schematic view of an optical path switching module of a projection device in a first state according to an embodiment of the disclosure. FIG. 1B is a schematic view of the optical path switching module of the projection device shown in FIG. 1A in a second state. Please refer to FIG. 1A and FIG. 1B at the same time. A projection device (such as a projector) 1A includes an illumination system 10A, a light valve 400, and a projection lens 500. The illumination system 10A is configured to provide an illumination beam IB. The light valve 400 is disposed on a transmission path of the illumination beam IB from the illumination system 10A. The light valve 400 is, for example, a digital micro-mirror device (DMD), a liquid-crystal-on-silicon panel (LCOS panel), or other appropriate spatial light modulator, which may be configured to convert the illumination beam IB into an image beam IM.

The projection lens 500 is disposed on a transmission path of the image beam IM from the light valve 400, and is adapted to project the image beam IM from the light valve 400 out of the projection device 1A. The projection lens 500 may be any type of lens module known to a person of ordinary skill in the art to which the disclosure belongs. For example, the projection lens 500 includes a combination of one or more optical lenses with refractive power, such as various combinations of non-planar lenses including biconcave lenses, biconvex lenses, concavo-convex lenses, convexo-concave lenses, plano-convex lenses, and plano-concave lenses. In an embodiment, the projection lens 500 may further include optical reflecting lenses to project the image beam IM from the light valve 400 onto a projection target in a reflecting manner. The foregoing is described with the illumination system 10A providing the illumination beam IB and applied in the projection device 1A. In other embodiments described later, other illumination systems may also be utilized to provide the illumination beam IB to be applied in the projection device 1A.

In an embodiment, the projection device 1A may further include a prism group 200, disposed on a transmission path of an illumination beam IB from an illumination system 10A, and configured to transmit the illumination beam IB to the light valve 400. In the embodiment, the prism group 200 may be a total internal reflection prism group (TIR prism group) combined by two prisms.

In the embodiment, the illumination system 10A includes a light source module 11, an optical path switching module 20A and a wavelength conversion layer 30. The light source module 11 includes a first light source 111 and a second light source 112. The first light source 111 is configured to emit a first light beam L1 (such as blue light). The second light source 112 is configured to emit a second light beam L2 (such as red light and/or green light). The first light beam L1 exits from the light source module 11 along a first direction (such as an X direction in FIG. 1A). The second light beam L2 exits from the light source module 11 along a second direction (such as a Y direction in FIG. 1A). The first direction is different from the second direction. In the embodiment, the X direction and Y direction may be substantially perpendicular. The first light source 111 is, for example, one or more blue laser diodes (LD). The second light source 112 is, for example, one or more red laser diodes and/or green laser diodes. In the embodiment, the first light source 111 and the second light source 112 of the light source module 11 are both positioned within the same package.

In an embodiment, the illumination system 10A may further include an optical path switching module 20B, a first dichroic element 50A, a second dichroic element 50B, a third dichroic element 50C, a first light homogenizing element 60A, a second light homogenizing element 60B, lenses 80, 81, 82, 83, 84 and 85, and reflecting mirrors 90, 91, 92 and 93. In an embodiment, the second light source 112 is, for example, one or more red laser diodes. The light source module 11 may further include a third light source 113 configured to emit a third light beam L3 (such as green light). The third light beam L3 exits from the light source module 11 along the second direction (such as the Y direction in FIG. 1A). The third light source 113 is, for example, one or more green laser diodes. The first light source 111, the second light source 112 and the third light source 113 are all positioned within the same package.

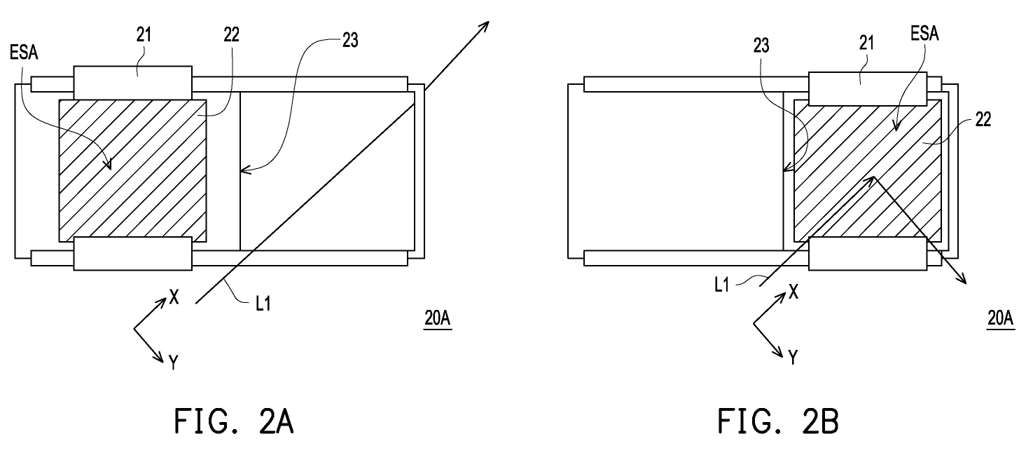

FIG. 2A to FIG. 2B are schematic side views of the optical path switching module shown in FIG. 1A and FIG. 1B in different states. Please refer to FIG. 1A, FIG. 1B, FIG. 2A and FIG. 2B at the same time. The optical path switching module 20A is disposed in the transmission path of the first light beam L1 from the first light source 111. The optical path switching module 20A includes a driving element 21 and an optical element 22. The driving element 21 is configured to generate motion (movement or rotation) of the optical element 22 to allow the optical path switching module 20A to switch between a first state and a second state to change the transmission path of the first light beam L1. In the embodiment, the driving element 21 may be a slide rail that is controlled by an electronic signal. For example, the user may change the light source mode of the projection device 1A by an operating interface to allow a processor (not shown) of the projection device 1A to control the driving element 21. As shown in FIG. 2A, the optical element 22 is, for example, a reflecting mirror connected to the slide rail. The optical element 22 is driven to move in a direction by the driving element 21 to allow the optical path switching module 20A to drive the optical element 22 to not be positioned in the transmission path of the first light beam L1 in the first state. As further shown in FIG. 2B, the optical path switching module 20A may drive the optical element 22 to be positioned in the transmission path of the first light beam L1 in the second state.

The optical path switching module 20A further includes an empty slot 23. The optical element 22 is driven by the driving element 21 to exit from the empty slot 23 (as shown in FIG. 2A), or the optical element 22 is driven by the driving element 21 to enter the empty slot 23 (as shown in FIG. 2B). When the optical path switching module 20A is in the first state, the empty slot 23 is positioned in the transmission path of the first light beam L1 so that the optical element 22 does not block the first light beam L1 from the light source module 11. The first light beam L1 may pass through the empty slot 23. When the optical path switching module 20A is in the second state, the optical element 22 is positioned in the empty slot 23, so that the first light beam L1 from the light source module 11 is reflected by the optical element 22.

In the embodiment, a quantity of the optical path switching module is at least two, that is the optical path switching module 20A and the optical path switching module 20B illustrated in FIG. 1A. The states of motion of the optical path switching modules 20A and 20B are synchronized. For example, when the optical path switching modules 20A and 20B are in the first state, the respective optical elements 22 are not positioned in the location of the empty slot 23. When the optical path switching modules 20A and 20B are in the second state, the respective optical elements 22 are positioned in the location of the empty slot 23. In some embodiments, the optical path switching module 20B may have the same structure and operating principle as the optical path switching module 20A, which will not be repeated here.

Please refer to FIG. 1A again. On the other hand, an extending plane ESA and an extending plane ESB of the two optical elements 22 of the optical path switching modules 20A and 20B have an included angle θ in a direction facing the light source module 11. In this way, when being in the second state (as shown in FIG. 1B), the two optical elements 22 of the optical path switching module 20A and the optical path switching module 20B are, for example, both positioned in the empty slot 23, so that the first light beam L1 is reflected back to the second dichroic element 50B in sequence by the two optical elements 22. In some embodiments, the included angle θ is less than 180 degrees. In an embodiment, the included angle θ may be substantially about 90 degrees.

FIG. 1C is a top view of the wavelength conversion element of the projection device shown in FIG. 1A. Please refer to FIG. 1A and FIG. 1C at the same time. The wavelength conversion layer 30 is disposed in the transmission path of the first light beam L1 from the first light source 111, or disposed in the transmission path of the first light beam L1 from the optical path switching module 20A. That is, the optical path switching module 20A is positioned between the light source module 11 and the wavelength conversion layer 30. The wavelength conversion layer 30 is configured to convert the first light beam L1 into a conversion beam LC. The illumination system 10A of the embodiment may include a wavelength conversion element 300. The wavelength conversion element 300 is, for example, a reflective phosphor wheel. The wavelength conversion element 300 includes the wavelength conversion layer 30 and a substrate 310 with high reflectivity. The wavelength conversion element 300 includes a conversion region R1 and a non-conversion region R2. The conversion region R1 and the non-conversion region R2 are positioned on the substrate 310. The wavelength conversion layer 30 is disposed on the conversion region R1. The non-conversion region R2 is configured to guide the first light beam L1 so that the first light beam L1 is reflected by the non-conversion region R2. For example, the non-conversion region R2 may be a part of the substrate 310 where no wavelength conversion layer 30 is disposed, or a reflecting mirror with high-reflectivity may be disposed on the non-conversion region R2. The wavelength conversion layer 30 is, for example, a phosphor layer or other wavelength conversion material, and configured to convert a light beam in the blue wavelength band into a light beam in the yellow wavelength band. In other embodiments, the conversion beam LC may also be a light beam in other wavelength bands.

When the optical path switching modules 20A and 20B are in the first state, the wavelength conversion layer 30 sequentially enters the transmission path of the first light beam L1. When the optical path switching modules 20A and 20B are in the second state, the wavelength conversion layer 30 is not positioned in the transmission path of the first light beam L1.

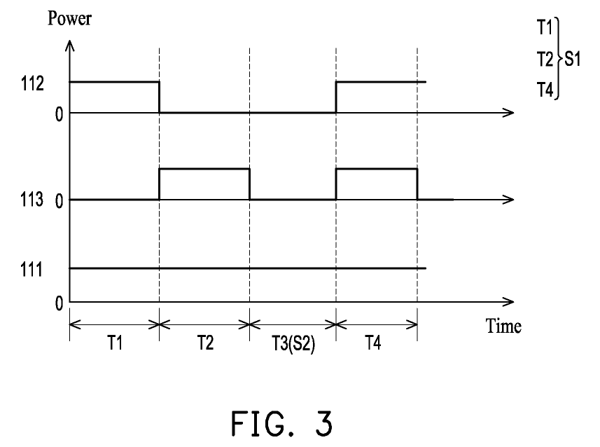

FIG. 3 is a timing diagram of the light source module shown in FIG. 1A. Please refer to FIG. 1A, FIG. 1C and FIG. 3. FIG. 3 respectively shows a schematic diagram of output power of the first light source 111, the second light source 112, and the third light source 113 over time. When the optical path switching modules 20A and 20B are in the first state, that is, when the illumination system 10A and the projection device 1A are in a first mode (such as a mixed light source mode), the first light beam L1 may be transmitted to the wavelength conversion element 300 through the optical path switching module 20A. The conversion region R1 and the non-conversion region R2 of the wavelength conversion element 300 shown in FIG. 1C sequentially enter the transmission path of the first light beam L1, and allow the conversion beam LC and the first light beam L1 to sequentially (such as a first time sequence S1 and a second time sequence S2) exit from the wavelength conversion element 300. For example, the wavelength conversion element 300 may include a motor (not shown) and a rotating shaft 320 connected to an output shaft of the motor. The motor may drive the wavelength conversion layer 30 to rotate through the rotating shaft 320. When the optical path switching modules 20A and 20B are in the first time sequence of the first state (such as in time intervals T1, T2, and T4), the first light beam L1 is incident on the wavelength conversion layer 30 of the conversion region R1 (as shown in FIG. 1A) through the optical path switching module 20A to generate the conversion beam LC. During the second time sequence S2 of the first state (such as in a time interval T3), the first light beam L1 is incident on the non-conversion region R2 to allow the first light beam L1 to be reflected.

For example, during the time interval T1, the first light source 111 and the second light source 112 are turned on at the same time, and the third light source 113 is turned off. At this time, the second light beam L2 is transmitted to the second dichroic element 50B, the first light homogenizing element 60A, the lens 82, the reflecting mirror 92, the lens 83, the third dichroic element 50C, and the second light homogenizing element 60B in sequence. The conversion beam LC from the wavelength conversion layer 30 passes through the lens 81 and the lens 80 in sequence, is reflected by the first dichroic element 50A to the third dichroic element 50C, and then passes through the third dichroic element 50C, and is transmitted to the second light homogenizing element 60B.

Next, during the time interval T2, the third light source 113 and the first light source 111 are turned on at the same time, and the second light source 112 is turned off. At this time, the third light beam L3 may be transmitted to the second light homogenizing element 60B following the same optical path as the second light beam L2. The conversion beam LC may also be transmitted to the second light homogenizing element 60B utilizing the same optical path as during the time interval T1.

Next, during the time interval T3, the first light source 111 remains turned on, and the second light source 112 and the third light source 113 are turned off at the same time. At this time, after being reflected by the non-conversion region R2, the first light beam L1 passes through the lens 81, the lens 80 and the first dichroic element 50A in sequence, and then is reflected by the reflecting mirrors 90 and 91 and the second dichroic element 50B in sequence, and then passes through the first light homogenizing element 60A, the lens 82, the reflecting mirror 92, the lens 83, and the third dichroic element 50C, and is finally transmitted to the second light homogenizing element 60B.

Next, during the time interval T4, the first light source 111, the second light source 112, and the third light source 113 are turned on at the same time. At this time, the second light beam L2, the third light beam L3, and the conversion beam LC are transmitted to the second light homogenizing element 60B. The time intervals T1, T2, T3, and T4 may repeatedly appear in sequence as time passes. The order of appearance of the time intervals T1, T2, T3, and T4 is not limited to that illustrated in FIG. 3, and may be in various possible order. In another embodiment, the second light source 112 and the third light source 113 may be turned on at the same time during the first time sequence S1 (that is, during the time intervals T1, T2, and T4) to emit the second light beam L2 and the third light beam L3 at the same time, and may only be turned off during the second time sequence S2.

In this way, when the optical path switching modules 20A and 20B are in the first state, the first light beam L1, the second light beam L2, the third light beam L3, and the conversion beam LC may be sequentially transmitted to the second light homogenizing element 60B to form the illumination beam IB. That is to say, the illumination beam IB includes at least one of the first light beam L1, the second light beam L2, the third light beam L3, and the conversion beam LC. Next, the illumination beam IB is transmitted to the lens 84, the reflecting mirror 93, the lens 85, the prism group 200, and the light valve 400 in sequence to be converted into the image beam IM. The projection lens 500 then projects the image beam IM out of the projection device 1A. Therefore, the projection device 1A may be in the mixed light source mode to provide a wider color gamut, enhancing the color performance of the image beam IM.

On the other hand, when the optical path switching modules 20A and 20B are in the second state, that is, when the illumination system 10A and the projection device 1A are in a second mode (such as a pure laser light source mode), the first light beam L1 is reflected by the optical path switching modules 20A and 20B at this time, so that the first light beam L1 may not be transmitted to the wavelength conversion layer 30. The first light beam L1 is transmitted to the optical path switching modules 20A and 20B, the second dichroic element 50B, the first light homogenizing element 60A, the lens 82, the reflecting mirror 92, the lens 83, the third dichroic element 50C, and the second light homogenizing element 60B in sequence. The second light beam L2 and the third light beam L3 may be respectively transmitted to the second dichroic element 50B, the first light homogenizing element 60A, the lens 82, the reflecting mirror 92, the lens 83, the third dichroic element 50C, and the second light homogenizing element 60B in sequence. In this way, the first light beam L1, the second light beam L2, and the third light beam L3 may be transmitted to the second light homogenizing element 60B in different time sequences to form the illumination beam IB. That is to say, the illumination beam IB includes at least one of the first light beam L1, the second light beam L2, and the third light beam L3. Therefore, the projection device 1A may be in the pure laser mode. In this way, the image beam IM may have higher color purity. In the pure laser mode, the response speed of the projection device 1A is shorter, that is, the switching speed to turn on and off the first light source 111, the second light source 112, and the third light source 113 is fast, which can effectively inhibit the phenomenon of color breaking.

In the embodiment, the first dichroic element 50A, the second dichroic element 50B, and the third dichroic element 50C are respectively, for example, dichroic mirrors. The first dichroic element 50A is disposed between the optical path switching module 20A and the wavelength conversion element 300. The first dichroic element 50A is configured to reflect the conversion beam LC and is configured to allow the first light beam L1 to pass through. For example, the first dichroic element 50A may be a dichroic mirror that allows a light beam in the yellow wavelength band to be reflected and allows a light beam in the blue wavelength band to pass through. The second dichroic element 50B is positioned between the light source module 11 and the first light homogenizing element 60A. The second dichroic element 50B is disposed in the transmission path of the second light beam L2 and the third light beam L3 from the light source module 11, and is positioned in the transmission path of the first light beam L1 from the optical path switching modules 20A and 20B, and/or in the transmission path of the first light beam L1 from the first dichroic element 50A. The second dichroic element 50B is configured to reflect the first light beam L1 and is configured to allow the second light beam L2 and the third light beam L3 to pass through. For example, the second dichroic element 50B may be a dichroic mirror that allows a light beam in the blue wavelength band to be reflected and allows a light beam in the red wavelength band to pass through and a light beam in the green wavelength band to pass through. The third dichroic element 50C is configured to reflect the first light beam L1, the second light beam L2, and the third light beam L3, and allow the conversion beam LC to pass through. For example, the third dichroic element 50C may be a dichroic mirror that only allows a light beam in the yellow wavelength band to pass through and reflects a light beam in other wavelength bands.

In the foregoing embodiment, the first light homogenizing element 60A is disposed in the transmission path of the second light beam L2 (and/or the third light beam L3) from the light source module 11, and is disposed in the transmission path of the first light beam L1 from the optical path switching modules 20A and 20B and/or the first dichroic element 50A. The second light homogenizing element 60B is disposed in the transmission path of the conversion beam LC from the first dichroic element 50A, and is disposed in the transmission path of the first light beam L1, the second light beam L2, and the third light beam L3 from the first light homogenizing element 60A. The first light homogenizing element 60A and the second light homogenizing element 60B are, for example, light integrating columns or lens arrays (such as fly eye lens). In the embodiment, the first light homogenizing element 60A is configured to solve the problem of laser speckle. The second light homogenizing element 60B is configured to adjust the light shape of the first light beam L1, the second light beam L2, the third light beam L3, and the conversion beam LC to be compatible with the shape of a light incident surface of the light valve 400 (such as rectangular). In other embodiments, the illumination system 10A may also include only a single light homogenizing element disposed in the transmission path of the first light beam L1, the second light beam L2, the third light beam L3, and the conversion beam LC. The quantity, refractive index, surface shape, or location of the lenses 80 to 85 may also be adjusted to enhance the transmission quality of each light beam.

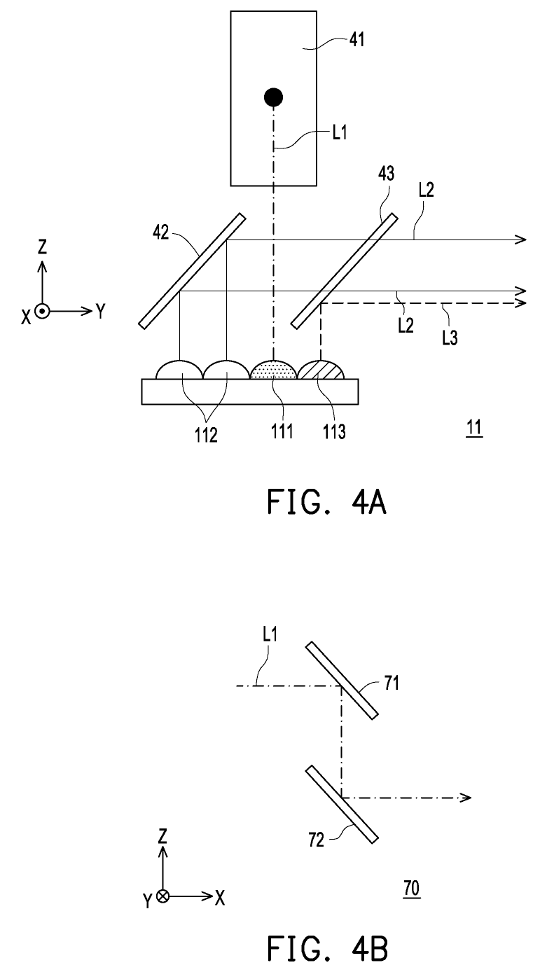

FIG. 4A is a schematic side view of the light source module shown in FIG. 1A viewed towards a -X direction. Please refer to FIG. 4A first. In the embodiment, the light source module 11 further includes an optical path separation element 40, configured to guide the first light beam L1 and the second light beam L2 (and/or the third light beam L3) to a first direction and a second direction. The first light beam L1 emitted by the first light source 111, the second light beam L2 emitted by the second light source 112, and the third light beam L3 emitted by the third light source 113 may all emit towards a third direction (such as a Z direction). The third direction is substantially perpendicular to the first direction and the second direction.

The optical path separation element 40 includes a first reflecting element 41, a second reflecting element 42, and a dichroic mirror 43. The emission directions of the first light source 111, the second light source 112, and the third light source 113 are all towards the Z direction, after which the first light beam L1 is reflected by the first reflecting element 41 and transmitted towards the X direction. The second reflecting element 42 is configured to reflect the second light beam L2 to allow the second light beam L2 to be transmitted towards the Y direction and pass through the dichroic mirror 43. After being reflected by the dichroic mirror 43, the third light beam L3 is also transmitted towards the Y direction.

FIG. 4B is a schematic side view of the light guide assembly shown in FIG. 1A viewed towards the Y direction. Please refer to FIG. 1A and FIG. 4B at the same time. In the embodiment, the illumination system 10A may further include a light guide assembly 70 (folding mirror). The light guide assembly 70 is disposed between the optical path separation element 40 and the optical path switching module 20A in the X direction, and configured to adjust the transmission location of the first light beam L1 in the Z direction. For example, the light guide assembly 70 may include a lens 71 and a lens 72. The first light beam L1 exits from the optical path separation element 40, and then may be reflected by the lens 71 and the lens 72 in sequence before exiting from the light guide assembly 70, so that the first light beam L1, the second light beam L2, and the third light beam L3 may be transmitted to the second light homogenizing element 60B at the same height in the Z direction.

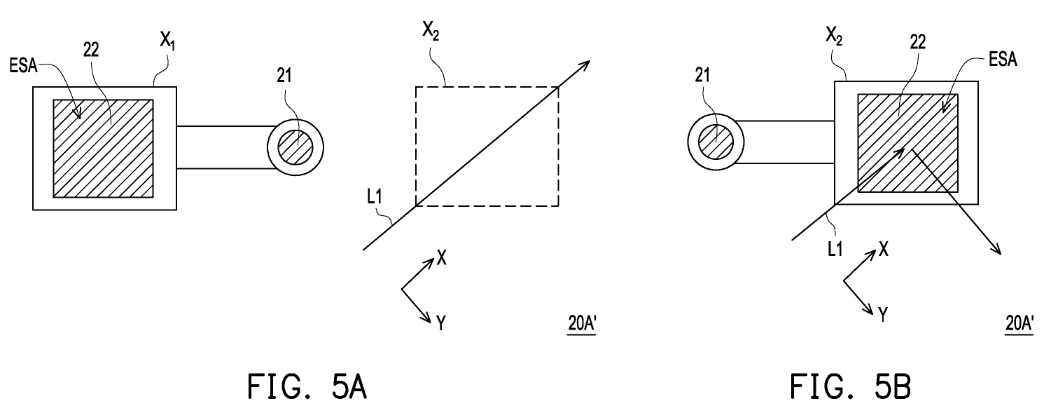

FIG. 5A to FIG. 5B are respectively schematic side views of an optical path switching module in different states according to another embodiment. Please refer to FIG. 5A and FIG. 5B again. Optical path switching modules 20A’ and 20B’ may be electronically controlled motor reflecting mirrors. The driving element 21 may be a driving motor. The optical element 22 may be a reflecting mirror. The driving element 21 is connected to the optical element 22 to drive the optical element 22 to move. First, refer to FIG. 5A. Taking the optical path switching module 20A’ as an example, when the optical path switching modules 20A’ and 20B’ are in the first state, the optical element 22 may be at a location X1 and not positioned in the transmission path of the first light beam L1. Then, refer to FIG. 5B. When the optical path switching modules 20A’ and 20B’ are in the second state, the driving element 21 drives the optical element 22 to rotate to a location X2 so that the optical element 22 is positioned in the transmission path of the first light beam L1 and allows the first light beam L1 to be reflected instead of being transmitted to the wavelength conversion layer 30. For related working principles, the foregoing paragraphs may be referred and will not be repeated here.

The following will enumerate some other embodiments to describe the disclosure in detail. The same components will be marked with the same reference numerals, and descriptions of the same technical content will be omitted. For the omitted parts, please refer to the foregoing embodiments, which will not be repeated here.

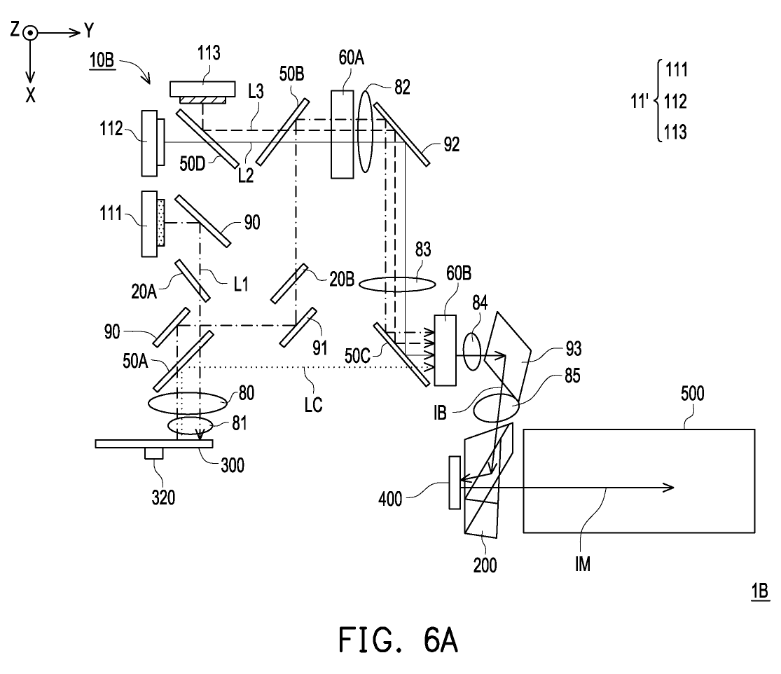

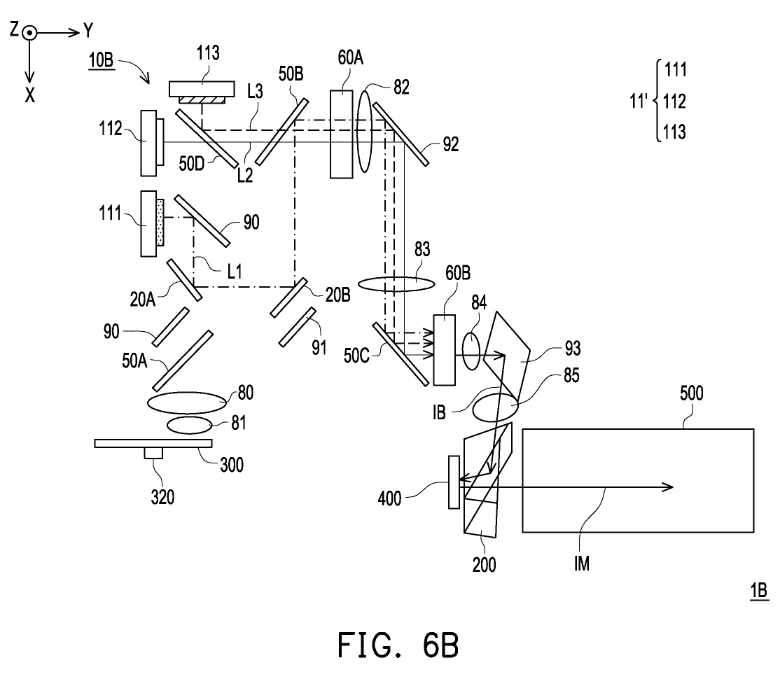

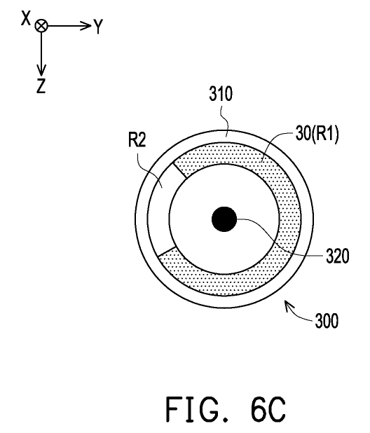

FIG. 6A is a schematic view of an optical path switching module of a projection device in a first state according to an embodiment of the disclosure. FIG. 6B is a schematic view of the optical path switching module of the projection device shown in FIG. 6A in a second state. FIG. 6C is a top view of the wavelength conversion element of the projection device shown in FIG. 6A. Please refer to FIG. 6A first. A projection device 1B and an illumination system 10B are similar to the projection device 1A and the illumination system 10A shown in FIG. 1A. The main difference is: a light source module 11’ of the projection device 1B and the illumination system 10B, where the first light source 111, the second light source 112, and the third light source 113 are each disposed in different packages.

Please refer to FIG. 6A and FIG. 6C at the same time. In detail, in the embodiment, the first light source 111 and the second light source 112 may be disposed side by side in the X direction, and emit the first light beam L1 and the second light beam L2 towards the Y direction. The third light source 113 may emit the third light beam L3 towards the X direction. When the optical path switching modules 20A and 20B are in the first time sequence S1 of the first state, the first light beam L1 may be transmitted to the reflecting mirror (positioned between the first light source 111 and the optical path switching module 20A) 90, the optical path switching module 20A, the first dichroic element 50A, the lenses 80 and 81, and the wavelength conversion layer 30 on the conversion region R1 of the wavelength conversion element 300 in sequence, and further generate the conversion beam LC. The conversion beam LC may then be transmitted to the lenses 81 and 80, the first dichroic element 50A, the third dichroic element 50C, and the second light homogenizing element 60B in sequence.

When the optical path switching modules 20A and 20B are in the second time sequence S2 of the first state, the first light beam L1 may be transmitted to the reflecting mirror 90 (positioned between the first light source 111 and the optical path switching module 20A), the optical path switching module 20A, the first dichroic element 50A, the lenses 80 and 81, and the non-conversion region R2 on the wavelength conversion element 300 in sequence, and further reflected by the non-conversion region R2. The reflected first light beam L1 may then be transmitted to the lenses 81 and 80, the first dichroic element 50A, the reflecting mirror 90 (positioned between the optical path switching module 20A and the wavelength conversion element 300), the reflecting mirror 91, the optical path switching module 20B, the second dichroic element 50B, the first light homogenizing element 60A, the lens 82, the reflecting mirror 92, the lens 83, the third dichroic element 50C, and the second light homogenizing element 60B in sequence.

The illumination system 10B may further include a fourth dichroic element 50D, disposed in the transmission path of the second light beam L2 and the third light beam L3 from the second light source 112 and the third light source 113. The fourth dichroic element 50D is, for example, configured to allow the second light beam L2 to pass through and allow the third light beam L3 to be reflected. In this way, the second light beam L2 and the third light beam L3 may both be transmitted towards the Y direction after existing from the fourth dichroic element 50D, and be transmitted to the second dichroic element 50B, the first light homogenizing element 60A, the lens 82, the reflecting mirror 92, the lens 83, the third dichroic element 50C, and the second light homogenizing element 60B in sequence. The illumination system 10B may also generate the foregoing illumination beam IB through the mixed light source mode, which will not be repeated here.

Please refer to FIG. 6B again. When being in the second state, the optical path switching modules 20A and 20B may change the transmission path of the first light beam L1 to allow the first light beam L1 to be transmitted to the reflecting mirror 90 (positioned between the first light source 111 and the optical path switching module 20A), the optical path switching modules 20A and 20B, and the second dichroic element 50B in sequence. Next, the first light beam L1 is reflected by the second dichroic element 50B to allow the first light beam L1 to be transmitted to the second light homogenizing element 60B following the same optical path as the second light beam L2 and the third light beam L3. In this way, the illumination system 10B may also generate the foregoing illumination beam IB through the pure laser mode. Based on the above, it can be understood that since the first light source 111, the second light source 112, and the third light source 113 in the illumination system 10B and the projection device 1B may be independently disposed, elements such as the light guide assembly 70 and the optical path separation element 40 shown in FIG. 1A may be omitted.

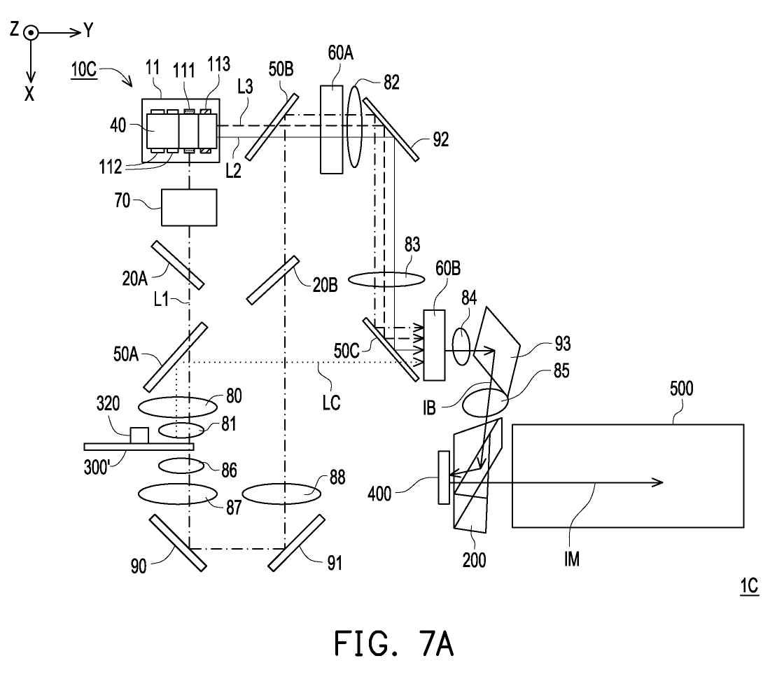

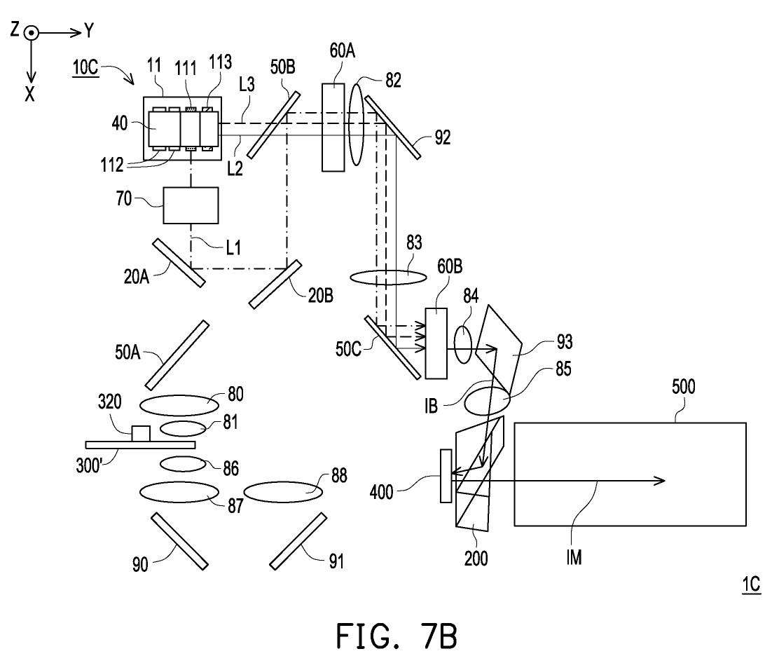

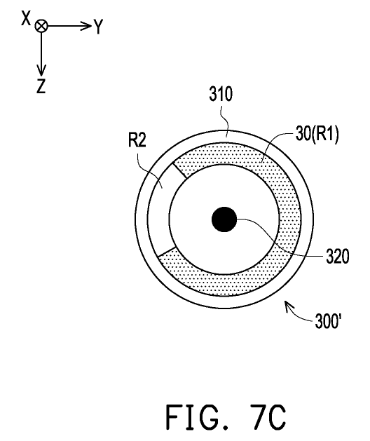

FIG. 7A is a schematic view of an optical path switching module of a projection device in a first state according to an embodiment of the disclosure. FIG. 7B is a schematic view of the optical path switching module of the projection device shown in FIG. 7A in a second state. FIG. 7C is a top view of the wavelength conversion element shown in FIG. 7A. Please refer to FIG. 7A and FIG. 7C first. A projection device 1C and an illumination system 10C are similar to the projection device 1A and the illumination system 10A in FIG. 1A. The main difference is: a wavelength conversion element 300’, which is, for example, a transmissive phosphor wheel. When the optical path switching modules 20A and 20B are in the first state, the wavelength conversion layer 30 sequentially enters the transmission path of the first light beam L1. When the first light beam L1 is transmitted to the non-conversion region R2, the first light beam L1 may pass through the non-conversion region R2.

In the illumination system 10C, the substrate 310 of the wavelength conversion element 300’ may be a light-transmitting substrate. Alternately, the non-conversion region R2 may be an optical element with high transmittance for the first light beam L1. Alternately, the non-conversion region R2 may be a hollow region on the substrate 310. When the optical path switching modules 20A and 20B are in the first time sequence S1 of the first state, the first light beam L1 may be transmitted to the optical path switching module 20A, the first dichroic element 50A, the lenses 80 and 81, and the wavelength conversion layer 30 on the wavelength conversion element 300’ in sequence, and further generate the conversion beam LC. The conversion beam LC may then be transmitted to the lenses 81 and 80, the first dichroic element 50A, the third dichroic element 50C, and the second light homogenizing element 60B in sequence. When the optical path switching modules 20A and 20B are in the second time sequence S2 of the first state, the first light beam L1 passes through the non-conversion region R2, and is transmitted to lenses 86 and 87, the reflecting mirror 90, the reflecting mirror 91, a lens 88, the optical path switching module 20B, and the second dichroic element 50B in sequence. Next, the first light beam L1 may be transmitted to the third dichroic element 50C following the same path as the second light beam L2 and the third light beam L3. Finally, the first light beam L1 may be transmitted to the second light homogenizing element 60B following the same path as the second light beam L2, the third light beam L3 and the conversion beam LC.

Please refer to FIG. 7B again. When the optical path switching modules 20A and 20B are in the second state, the optical path of the illumination system 10C is the same as the optical path of the illumination system 10A shown in FIG. 1B. The first light beam L1 from the light source module 11 is reflected by the optical path switching modules 20A and 20B, so that the first light beam L1 may not be transmitted to the wavelength conversion layer 30. The first light beam L1 is transmitted to the optical path switching modules 20A and 20B, the second dichroic element 50B, the first light homogenizing element 60A, the lens 82, the reflecting mirror 92, the lens 83, the third dichroic element 50C, and the second light homogenizing element 60B in sequence. The second light beam L2 and the third light beam L3 may be transmitted to the second dichroic element 50B, the first light homogenizing element 60A, the lens 82, the reflecting mirror 92, the lens 83, the third dichroic element 50C, and the second light homogenizing element 60B in sequence. In this way, the first light beam L1, the second light beam L2, and the third light beam L3 may also be transmitted to the second light homogenizing element 60B in sequence according to different time sequences to form the illumination beam IB. Therefore, the projection device 1C may also have advantages similar to those of the foregoing projection device 1A. For related paragraphs, the foregoing descriptions may be referred and will not be repeated here.

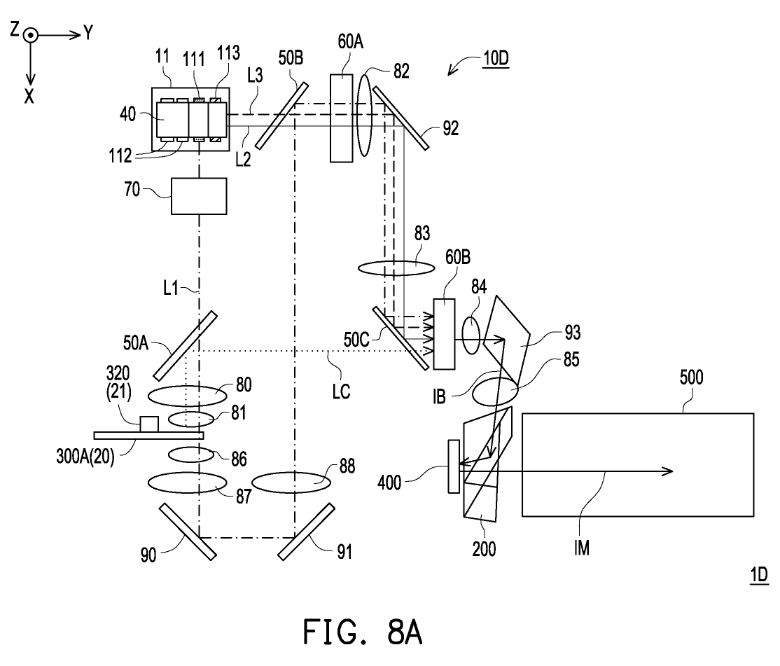

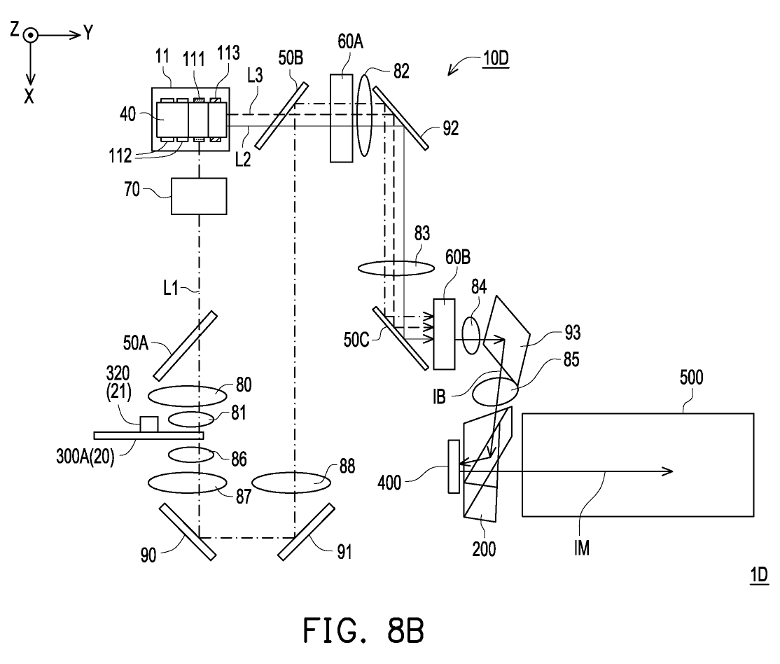

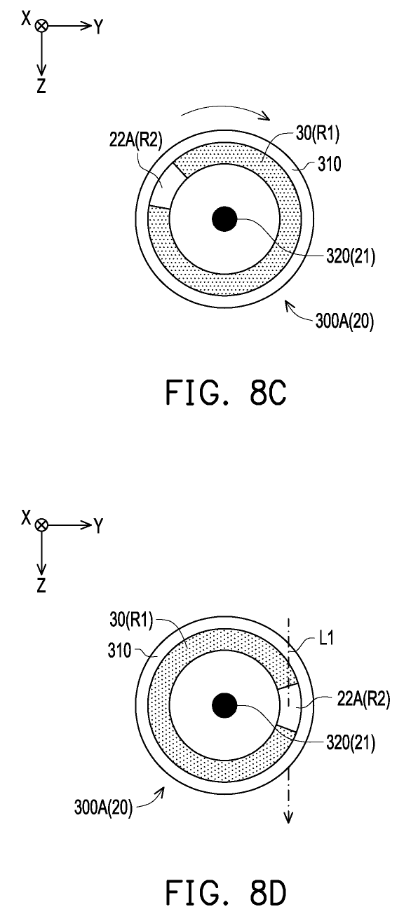

FIG. 8A is a schematic view of an optical path switching module of a projection device in a first state according to an embodiment of the disclosure. FIG. 8B is a schematic view of the optical path switching module of the projection device shown in FIG. 8A in a second state. FIG. 8C is a top view of the wavelength conversion element when the optical path switching module of the projection device shown in FIG. 8A is in the first state. FIG. 8D is a top view of the wavelength conversion element when the optical path switching module of the projection device shown in FIG. 8B is in the second state. Please refer to FIG. 8A and FIG. 8C first. A projection device 1D and an illumination system 10D are similar to the projection device 1C and the illumination system 10C in FIG. 7A. The main difference is that: the optical path switching module 20 is a wavelength conversion element 300A. The wavelength conversion layer 30 is positioned on the optical path switching module 20. Alternately, the wavelength conversion layer 30 is positioned between the light source module 11 and the optical path switching module 20. In the embodiment, the driving element 21 may include a motor and the rotating shaft 320. The output shaft of the motor may be connected to the rotating shaft 320 of the wavelength conversion element 300A. The motor is configured to drive the wavelength conversion layer 30 positioned in the conversion region R1 and the optical element 22A positioned in the non-conversion region R2 to rotate. The optical element 22A of the optical path switching module 20 is configured to guide the first light beam L1, so that the first light beam L1 may pass through the non-conversion region R2.

In the embodiment, the optical element 22A is an optical transmissive element. When the wavelength conversion element 300A (the optical path switching module 20) is in the first state, the driving element 21 continues to operate. The driving element 21 is configured to allow the wavelength conversion layer 30 (the conversion region R1) and the optical element 22A (the non-conversion region R2) to sequentially enter the transmission path of the first light beam L1. When the optical path switching module 20 is in the first time sequence S1 of the first state, the first light beam L1 may be transmitted to the wavelength conversion layer 30 on the wavelength conversion element 300A through the first dichroic element 50A, the lenses 80 and 81 in sequence, and further generate the conversion beam LC. The conversion beam LC may then be transmitted to the lenses 81 and 80, the first dichroic element 50A, the third dichroic element 50C, and the second light homogenizing element 60B in sequence. When the optical path switching module 20 is in the second time S2 of the first state, the first light beam L1 may pass through the non-conversion region R2, and be transmitted to the lenses 86 and 87, the reflecting mirrors 90 and 91, the lens 88, and the second dichroic element 50B in sequence. Next, the first light beam L1 may be transmitted to the third dichroic element 50C following the same path as the second light beam L2 and the third light beam L3. Finally, the first light beam L1 may be transmitted to the second light homogenizing element 60B following the same path as the second light beam L2, the third light beam L3 and the conversion beam LC.

Next, please refer to FIG. 8B and FIG. 8D. The user may change the light source mode of the projection device 1D by the operating interface, so that when the wavelength conversion element 300A (the optical path switching module 20) is in the second state, the driving element 21 is configured to allow the non-conversion region R2 to be positioned in the transmission path of the first light beam L1. At this time, the driving element 21 may stop operating, and allow the non-conversion region R2 to remain positioned in the transmission path of the first light beam L1. Therefore, the first light beam L1 is transmitted to the first dichroic element 50A, the lenses 80 and 81, the non-conversion region R2, the lenses 86 and 87, the reflecting mirrors 90 and 91, the lens 88, and the second dichroic element 50B in sequence. Next, the first light beam L1 may be transmitted to the second light homogenizing element 60B following the same path as the second light beam L2 and the third light beam L3 to form the foregoing illumination beam IB. In this way, the first light beam L1, the second light beam L2, and the third light beam L3 may also be transmitted to the light valve 400 in different time sequences.

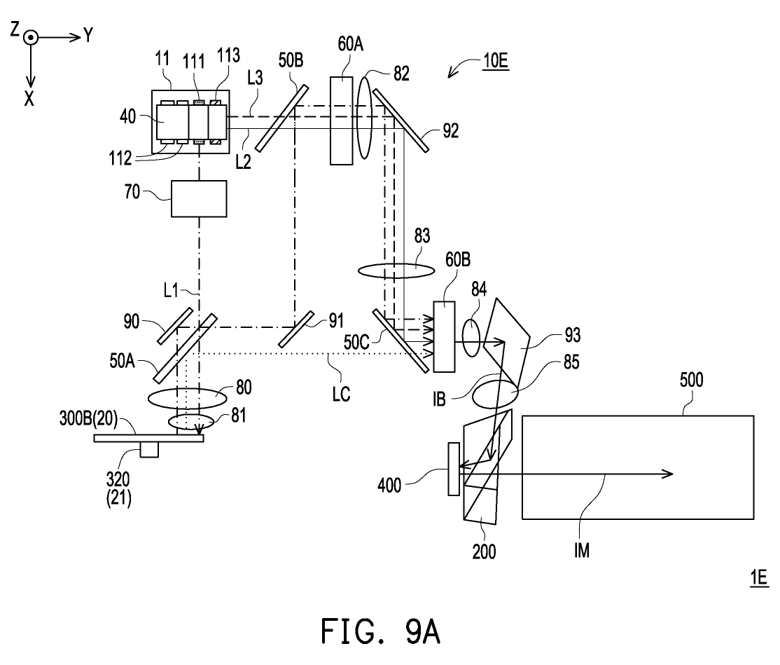

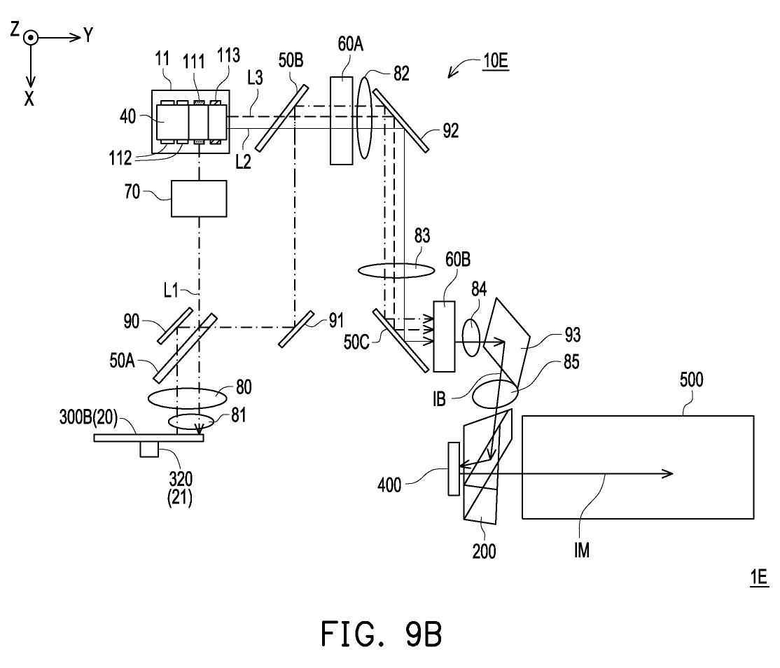

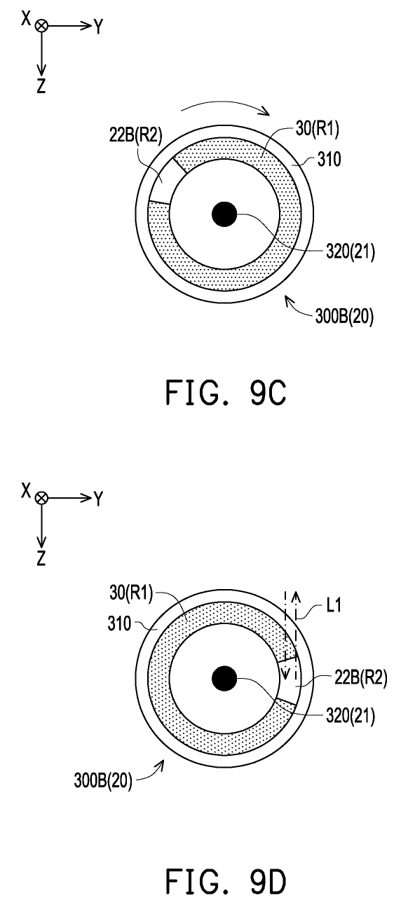

FIG. 9A is a schematic view of an optical path switching module of a projection device in a first state according to an embodiment of the disclosure. FIG. 9B is a schematic view of the optical path switching module of the projection device shown in FIG. 9A in a second state. FIG. 9C is a top view of the wavelength conversion element when the optical path switching module of the projection device shown in FIG. 9A is in the first state. FIG. 9D is a top view of the wavelength conversion element when the optical path switching module of the projection device shown in FIG. 9B is in the second state. Please refer to FIG. 9A and FIG. 9C first. A projection device 1E and an illumination system 10E are similar to the projection device 1D and illumination system 10D shown in FIG. 8A. The main difference is that: a wavelength conversion element 300B (the optical path switching module 20) is a reflective phosphor wheel. An optical element 22B is configured to guide the first light beam L1, so that the first light beam L1 is reflected by the non-conversion region R2.

Please refer to FIG. 9A and FIG. 9C at the same time. The optical element 22B is a reflective element. For example, the optical element 22B may be a plane mirror or a coating layer with high reflectivity for the first light beam L1. When the wavelength conversion element 300B (the optical path switching module 20) is in the first state, the driving element 21 is configured to allow the conversion region R1 and the non-conversion region R2 to sequentially enter the transmission path of the first light beam L1. For example, in the first time sequence S1 of the first state, the first light beam L1 may be transmitted to the wavelength conversion layer 30 on the wavelength conversion element 300B through the first dichroic element 50A, the lenses 80 and 81, and further generate the conversion beam LC. The conversion beam LC may then be transmitted to the lenses 81 and 80, the first dichroic element 50A, the third dichroic element 50C, and the second light homogenizing element 60B in sequence.

When the wavelength conversion element 300B is in the second time sequence S2 of the first state, after being reflected by the non-conversion region R2, the first light beam L1 passes through the lens 81, the lens 80, the first dichroic element 50A in sequence, and then is reflected by the reflecting mirrors 90 and 91 and the second dichroic element 50B in sequence, and then is transmitted to the first light homogenizing element 60A, the lens 82, the reflecting mirror 92, the lens 83, the third dichroic element 50C and the second light homogenizing element 60B in sequence. The first light beam L1 may form the foregoing illumination beam IB following the same path as the second light beam L2, the third light beam L3 and the conversion beam LC.

Next, please refer to FIG. 9B and FIG. 9D. The user may change the light source mode of the projection device 1E by the operating interface, so that when the wavelength conversion element 300B (the optical path switching module 20) is in the second state, the driving element 21 is configured to allow the non-conversion region R2 to be positioned in the transmission path of the first light beam L1. At this time, the driving element 21 may stop operating, and allow the non-conversion region R2 to remain positioned in the transmission path of the first light beam L1. The first light beam L1 is transmitted to the non-conversion region R2 through the first dichroic element 50A, the lenses 80 and 81 in sequence. Next, the first light beam L1 is reflected by the optical element 22B positioned on the non-conversion region R2, and transmitted to the lens 81, the lens 80, the first dichroic element 50A, the reflecting mirrors 90 and 91 and the second dichroic element 50B in sequence. Next, the first light beam L1 may be transmitted to the second light homogenizing element 60B following the same path as the second light beam L2 and the third light beam L3 to form the foregoing illumination beam IB. In this way, the first light beam L1, the second light beam L2 and the third light beam L3 may also be transmitted to the light valve 400 in different time sequences.

In summary, the illumination system and the projection device according to the embodiment of the disclosure have at least one of the following advantages or effects. In the illumination system and the projection device according to the embodiment of the disclosure, the optical path switching module is disposed in the transmission path of the first light beam. By utilizing the driving element and the optical element of the optical path switching module, the optical path switching module may switch between the first state and the second state, so that the illumination system and the projection device may switch between the mixed light source mode and the pure laser light source mode. In this way, corresponding to the needs of different images, the illumination system and the projection device can both generate appropriate images for the user to view, enhancing the versatility of the illumination system and the projection device.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from the disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the disclosure is intended to be dedicated to the public regardless of whether the element or component is explicitly recited in the following claims.

What is claimed is:

1. An illumination system, comprising:
a light source module, comprising:
a first light source, configured to emit a first light beam; and
a second light source, configured to emit a second light beam, wherein the first light beam exits from the light source module along a first direction, the second light beam exits from the light source module along a second direction, and the first direction is different from the second direction;
an optical path switching module, disposed in a transmission path of the first light beam from the first light source, wherein the optical path switching module comprises a driving element and an optical element, and the driving element is configured to generate motion of the optical element, so that the optical path switching module switches between a first state and a second state to change the transmission path of the first light beam; and
a wavelength conversion layer, disposed in the transmission path of the first light beam from the first light source or the optical path switching module, and configured to convert the first light beam into a conversion beam,
wherein when the optical path switching module is in the first state, the wavelength conversion layer sequentially enters the transmission path of the first light beam, and when the optical path switching module is in the second state, the wavelength conversion layer is not positioned in the transmission path of the first light beam.

2. The illumination system according to claim 1, wherein the light source module further comprises an optical path separation element, configured to guide the first light beam and the second light beam to the first direction and the second direction.

3. The illumination system according to claim 2, wherein the first direction is perpendicular to the second direction, the first light beam emitted by the first light source and the second light beam emitted by the second light source are both emitted towards a third direction, and the third direction is perpendicular to the first direction and the second direction.

4. The illumination system according to claim 1, wherein the driving element is configured to drive the optical element to move or rotate, and when the optical path switching module is in the first state, the optical element is not positioned in the transmission path of the first light beam, and when the optical path switching module is in the second state, the optical element is positioned in the transmission path of the first light beam.

5. The illumination system according to claim 4, wherein the optical path switching module further comprises an empty slot, the optical element is driven by the driving element to enter or exit from the empty slot, and when the optical path switching module is in the first state, the empty slot is positioned in the transmission path of the first light beam, and when the optical path switching module is in the second state, the optical element is positioned in the empty slot.

6. The illumination system according to claim 4, wherein a quantity of the optical path switching module is at least two, and states of motion of the at least two optical path switching modules are synchronized.

7. The illumination system according to claim 4, wherein a quantity of the optical path switching module is two, extending planes of the two optical elements of the two optical path switching modules have an included angle in a direction facing the light source module.

8. The illumination system according to claim 1, further comprising a wavelength conversion element, wherein the wavelength conversion element comprises:
a conversion region, wherein the wavelength conversion layer is disposed on the conversion region; and
a non-conversion region, configured to guide the first light beam, so that the first light beam is reflected by the non-conversion region, or the first light beam passes through the non-conversion region,
wherein when the optical path switching module is in the first state, the conversion region and the non-conversion region sequentially enter the transmission path of the first light beam, so that the conversion beam and the first light beam sequentially exit from the wavelength conversion element.

9. The illumination system according to claim 8, further comprising a first dichroic element, disposed between the optical path switching module and the wavelength conversion element, wherein the first dichroic element is configured to reflect the conversion beam and configured to allow the first light beam to pass through.

10. The illumination system according to claim 9, further comprising a first light homogenizing element and a second light homogenizing element, wherein the first light homogenizing element is disposed in a transmission path of the second light beam from the light source module, and disposed in the transmission path of the first light beam from the optical path switching module or the first dichroic element, and the second light homogenizing element is disposed in a transmission path of the conversion beam from the first dichroic element, and disposed in the transmission paths of the first light beam and the second light beam from the first light homogenizing element.

11. The illumination system according to claim 10, further comprising a second dichroic element, positioned between the light source module and the first light homogenizing element, wherein the second dichroic element is disposed in the transmission path of the second light beam from the light source module, and positioned in the transmission path of the first light beam from the optical path switching module or the first dichroic element, and the second dichroic element is configured to reflect the first light beam and configured to allow the second light beam to pass through.

12. The illumination system according to claim 1, wherein the optical path switching module is a wavelength conversion element, and the wavelength conversion element comprises:
a conversion region, wherein the wavelength conversion layer is disposed on the conversion region;
a non-conversion region, wherein the optical element is disposed on the non-conversion region, and configured to guide the first light beam, so that the first light beam is reflected by the optical element, or the first light beam passes through the optical element; and
the driving element, configured to drive the wavelength conversion layer and the optical element to rotate, wherein
when the wavelength conversion element is in the first state, the driving element is configured to allow the wavelength conversion layer and the optical element to sequentially enter the transmission path of the first light beam; and
when the wavelength conversion element is in the second state, the driving element is configured to allow the optical element to be positioned in the transmission path of the first light beam.

13. The illumination system according to claim 12, wherein the optical element is a reflective element or an optical transmissive element.

14. The illumination system according to claim 12, further comprising a first dichroic element, disposed between the light source module and the wavelength conversion element, wherein the first dichroic element is configured to reflect the conversion beam and configured to allow the first light beam to pass through.

15. The illumination system according to claim 14, further comprising a first light homogenizing element and a second light homogenizing element, wherein the first light homogenizing element is disposed in a transmission path of the second light beam from the light source module, and disposed in the transmission path of the first light beam from the first dichroic element, and the second light homogenizing element is disposed in a transmission path of the conversion beam from the first dichroic element, and disposed in the transmission paths of the first light beam and the second light beam from the first light homogenizing element.

16. The illumination system according to claim 15, further comprising a second dichroic element, positioned between the light source module and the first light homogenizing element, wherein the second dichroic element is disposed in the transmission path of the second light beam from the light source module, and positioned in the transmission path of the first light beam, and the second dichroic element is configured to reflect the first light beam and configured to allow the second light beam to pass through.

17. A projection device, comprising:
an illumination system, configured to provide an illumination beam, and the illumination system comprising:
a light source module, comprising
a first light source, configured to emit a first light beam; and
a second light source, configured to emit a second light beam, wherein the first light beam exits from the light source module along a first direction, the second light beam exits from the light source module along a second direction, and the first direction is different from the second direction;
an optical path switching module, disposed in a transmission path of the first light beam from the first light source, wherein the optical path switching module comprises a driving element and an optical element, the driving element is configured to generate motion of the optical element, so that the optical path switching module switches between a first state and a second state to change the transmission path of the first light beam; and
a wavelength conversion layer, disposed in the transmission path of the first light beam from the first light source or the optical path switching module, wherein the wavelength conversion layer is configured to convert the first light beam into a conversion beam, wherein when the optical path switching module is in the first state, the wavelength conversion layer sequentially enters the transmission path of the first light beam, and when the optical path switching module is in the second state, the wavelength conversion layer is not positioned in the transmission path of the first light beam;
a light valve, disposed in a transmission path of the illumination beam, and configured to convert the illumination beam into an image beam, wherein the illumination beam comprises at least one of the first light beam, the second light beam and the conversion beam; and
a projection lens, disposed in a transmission path of the image beam, and configured to project the image beam out of the projection device.

18. The projection device according to claim 17, wherein the driving element is configured to drive the optical element to move or rotate, and when the optical path switching module is in the first state, the optical element is not positioned in the transmission path of the first light beam, and when the optical path switching module is in the second state, the optical element is positioned in the transmission path of the first light beam.

19. The projection device according to claim 17, wherein the optical path switching module is a wavelength conversion element, and the wavelength conversion element comprises:
a conversion region, wherein the wavelength conversion layer is disposed on the conversion region; and
a non-conversion region, wherein the optical element is disposed on the non-conversion region, and configured to guide the first light beam, so that the first light beam is reflected by the optical element, or the first light beam passes through the optical element; and
the driving element, configured to drive the wavelength conversion layer and the optical element to rotate, wherein
when the wavelength conversion element is in the first state, the driving element is configured to allow the wavelength conversion layer and the optical element to sequentially enter the transmission path of the first light beam; and
when the wavelength conversion element is in the second state, the driving element is configured to allow the optical element to be positioned in the transmission path of the first light beam.
